(19) United States
(12) Patent Application Publication
(10) Pub. No.: US 2025/0297638 A1
(43) Pub. Date: Sep. 25, 2025

(54) POWER TRANSMISSION SHAFT AND VEHICLE EQUIPPED THE SAME

(71) Applicant: MITSUBISHI HEAVY INDUSTRIES, LTD., Tokyo (JP)

(72) Inventors: Kazuhiro MIURA, Tokyo (JP); Kentaro SHINDO, Tokyo (JP); Mikoto OMORI, Tokyo (JP)

(73) Assignee: MITSUBISHI HEAVY INDUSTRIES, LTD., Tokyo (JP)

(21) Appl. No.: 18/863,431

(22) PCT Filed: Feb. 15, 2023
(86) PCT No.: PCT/JP2023/005193

§ 371 Date: Nov. 6, 2024

(30) Foreign Application Priority Data
May 11, 2022 (JP) 2022-078136

(51) Int. Cl. F16C 3/02

(52) U.S. Cl. CPC F16C 3/026; F16C 3/023

(57) ABSTRACT

A power transmission shaft of the present disclosure connects two rotating devices with each other, and is capable of transmitting power from one device to the other device. The power transmission shaft comprises an FRP shaft extending around an axis, and a pair of metal flanges connected to the FRP shaft in an axial direction. The FRP shaft has a first cylindrical part, and a pair of second cylindrical parts integrally connected to the first cylindrical part. The second cylindrical parts each have a base part connected to the first cylindrical part, and a plurality of protruding parts that protrude from the base part in the axial direction, the plurality of protruding parts being disposed spaced apart from each other at equal intervals in a circumferential direction and thereby forming, together with the base part, a plurality of keyways extending in the axial direction. The metal flanges each have a connection part that is connected rotatably to a device, and a plurality of keys that protrude from the connection part in the axial direction and individually fit into the keyways. The thickness of the protruding parts in the circumferential direction is larger than the thickness of the keys in the circumferential direction.

### TECHNICAL FIELD

The present disclosure relates to a power transmission shaft and a vehicle equipped the same.

Priority is claimed on Japanese Patent Application No. 2022-078136, filed May 11, 2022, the content of which is incorporated herein by reference.

### BACKGROUND ART

For example, PTL 1 discloses a fiber reinforced plastic (FRP) drive shaft used as a propeller shaft (power transmission shaft) of a vehicle. In this FRP drive shaft, the corrugated engagement portions of the FRP cylinder and the metal abutting collar are in surface contact with each other, and the end joint is disposed across the inside of the FRP cylinder and the inside of the abutting collar. A serration portion to be press-fitted into the FRP cylinder and the abutting collar is formed on the outer peripheral surface of the end joint.

Accordingly, when torque is transmitted between the end joint and the FRP cylinder, the torque is simultaneously applied to the inside and the outside of the FRP cylinder via the corrugated engagement portions in surface contact with each other. Therefore, the FRP cylinder is less likely to be damaged due to the torque load.

### CITATION LIST

### Patent Literature

[PTL 1] Japanese Unexamined Patent Application Publication No. 2011-52720

### SUMMARY OF INVENTION

### Technical Problem

In recent years, there has been a demand for a power transmission shaft for a vehicle capable of transmitting large torque.

In the FRP drive shaft described in PTL 1, there is a high probability that the thicknesses of the corrugated engagement portions of the FRP cylinder and the abutting collar in the circumferential direction are the same. For this reason, as the torque is increased, stress is concentrated on the FRP cylinder and the abutting collar, and as a result, deformation or the like caused by a difference in a material constituting the FRP cylinder and the abutting collar may not be negligible.

The present disclosure has been made to solve the above problem, and an object of the present disclosure is to provide a power transmission shaft capable of transmitting a larger torque, and a vehicle including the power transmission shaft.

### Solution to Problem

In order to solve the above problem, a power transmission shaft according to the present disclosure is a power transmission shaft for connecting two rotating devices to each other and capable of transmitting power from one device to the other device, including: an FRP shaft extending about an axis; and a pair of metal flanges connected to the FRP shaft in the axial direction, in which the FRP shaft includes a first cylindrical portion and a pair of second cylindrical portions integrally connected to the first cylindrical portion, the second cylindrical portion includes a base portion connected to the first cylindrical portion and a protruding portion protruding from the base portion in the axial direction and disposed at equal intervals in a circumferential direction with gaps therebetween to form a plurality of key grooves extending in the axial direction together with the base portion, the metal flange includes a connection portion rotatably connected to the device and a plurality of keys protruding from the connection portion in the axial direction and fitted into the key grooves one by one, and a thickness of the protruding portion in the circumferential direction is larger than a thickness of the key in the circumferential direction.

A vehicle according to the present disclosure includes the power transmission shaft described above.

### Advantageous Effects of Invention

According to the present disclosure, it is possible to provide a power transmission shaft capable of transmitting a larger torque, and a vehicle equipped the same.

### BRIEF DESCRIPTION OF DRAWINGS

FIG. 1 is a top view of a schematic configuration of a vehicle according to an embodiment of the present disclosure.

FIG. 2 is a side view of a schematic configuration of the vehicle according to the embodiment of the present disclosure.

FIG. 3 is an exploded perspective view of the power transmission shaft according to the embodiment of the present disclosure.

FIG. 4 is a partial cross-sectional view taken along line IV-IV in FIG. 3.

FIG. 5 is a partial cross-sectional view taken along line V-V in FIG. 3.

FIG. 6 is a partial cross-sectional view of a power transmission shaft according to another embodiment of the present disclosure, which corresponds to the portion shown in FIG. 4.

FIG. 7 is a partial cross-sectional view of a power transmission shaft according to another embodiment of the present disclosure, which corresponds to the portion shown in FIG. 5.

FIG. 8 is a partial cross-sectional view of a power transmission shaft according to another embodiment of the present disclosure, which corresponds to the portion shown in FIG. 4.

FIG. 9 is a partial cross-sectional view of a power transmission shaft according to another embodiment of the present disclosure, which corresponds to the portion shown in FIG. 5.

FIG. 10 is a view of a second cylindrical portion of an FRP shaft according to another embodiment of the present disclosure when viewed in the axial direction from one side or the other side.

FIG. 11 is a view of a metal flange portion according to another embodiment of the present disclosure when viewed in the axial direction from the FRP shaft side.

### DESCRIPTION OF EMBODIMENTS

Hereinafter, embodiments of a vehicle according to the present disclosure will be described with reference to the accompanying drawings.

### (Vehicle)

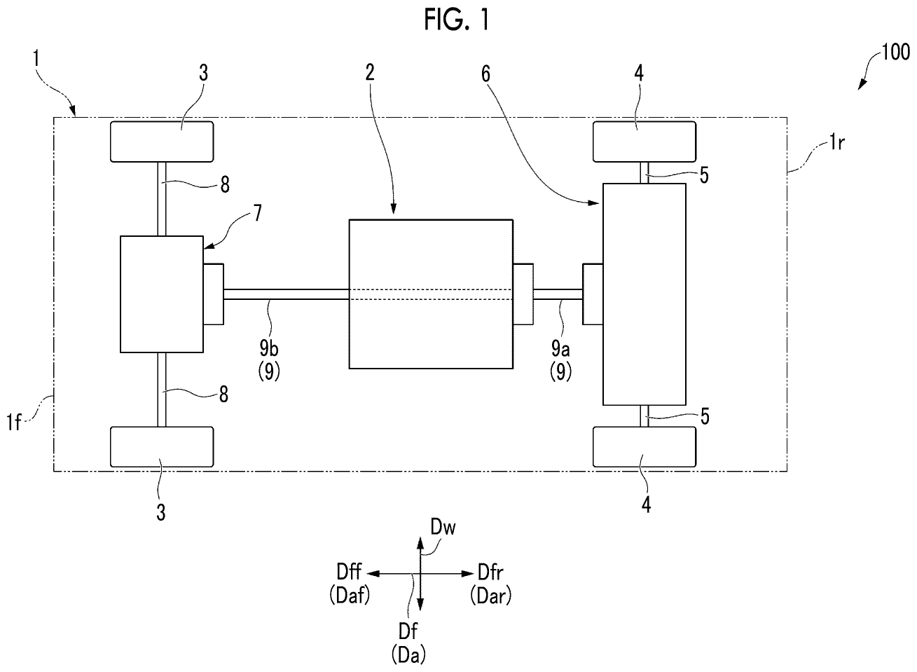

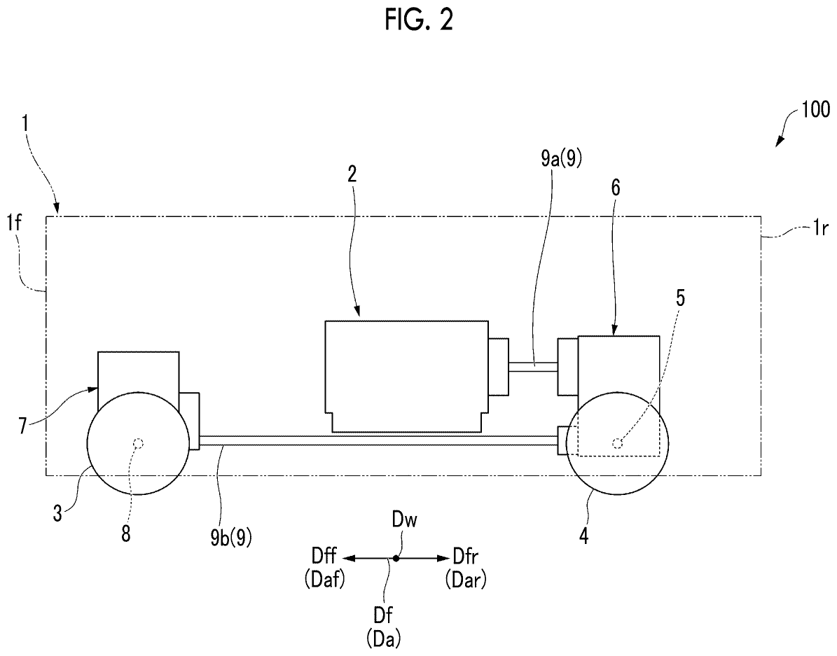

The vehicle in the present embodiment is a vehicle for traveling on rough terrain. As shown in FIG. 1 and FIG. 2, the vehicle 100 includes a vehicle body 1, an engine 2, drive wheels 3, driven wheels 4, a rear wheel drive shaft 5, a rear power distribution unit 6, a front power distribution unit 7, a front wheel drive shaft 8, a first power transmission shaft 9a (power transmission shaft), and a second power transmission shaft 9b (power transmission shaft).

The vehicle body 1 is a car body forming an outer shell of the vehicle 100. Hereinafter, for convenience of description, the front-rear direction of the vehicle body 1 is simply referred to as a “front-rear direction Df”, and the left-right direction (vehicle width direction) of the vehicle body 1 is simply referred to as a “left-right direction Dw”. Further, a front side in the front-rear direction Df is referred to as a “front side Dff”, and a rear side in the front-rear direction Df is referred to as a “rear side Dfr”. The engine 2 is disposed inside the vehicle body 1.

The drive wheels 3 are rotated by driving of the engine 2. The drive wheels 3 in the present embodiment are disposed on the front side Dff of the engine 2. A pair of drive wheels 3 are disposed at an interval in the left-right direction Dw of the vehicle body 1. The driven wheels 4 are disposed on the rear side Dfr of the engine 2. A pair of driven wheels 4 in the present embodiment are disposed at an interval in the left-right direction Dw of the vehicle body 1.

The rear power distribution unit 6 is disposed in a region on the rear side Dfr of the engine 2 in the vehicle body 1. A first power transmission shaft 9a extends from the engine 2 toward the rear side Dfr. The rear power distribution unit 6 is connected to the rear end of the first power transmission shaft 9a. The first power transmission shaft 9a transmits power from the engine 2 to the rear power distribution unit 6.

The rear power distribution unit 6 has a function of transmitting a part of the power from the first power transmission shaft 9a to the rear wheel drive shaft 5 by changing the rotational speed of the first power transmission shaft 9a. In addition, the rear power distribution unit 6 distributes power from the engine 2 into power to the front power distribution unit 7 and power to the rear wheel drive shaft 5.

The front power distribution unit 7 is disposed between the pair of drive wheels 3 in the vehicle body 1. The front power distribution unit 7 is disposed on the front side Dff of the engine 2. The second power transmission shaft 9b extends from the rear power distribution unit 6 to the front side Dff. The front end of the second power transmission shaft 9b is connected to the front power distribution unit 7. The second power transmission shaft 9b is disposed below the engine 2. The second power transmission shaft 9b transmits the power from the rear power distribution unit 6 to the front power distribution unit 7.

The front wheel drive shaft 8 extends in the left-right direction Dw from the front power distribution unit 7. The drive wheels 3 are attached to both ends of the front wheel drive shaft 8. The front power distribution unit 7 has a function of transmitting power from the second power transmission shaft 9b to the front wheel drive shaft 8 by changing the rotational speed of the second power transmission shaft 9b.

The first power transmission shaft 9a and the second power transmission shaft 9b described above basically have the same configuration except for configurations such as dimensions. Therefore, hereinafter, the first power transmission shaft 9a and the second power transmission shaft 9b are collectively referred to as a “power transmission shaft 9”.

### (Power Transmission Shaft)

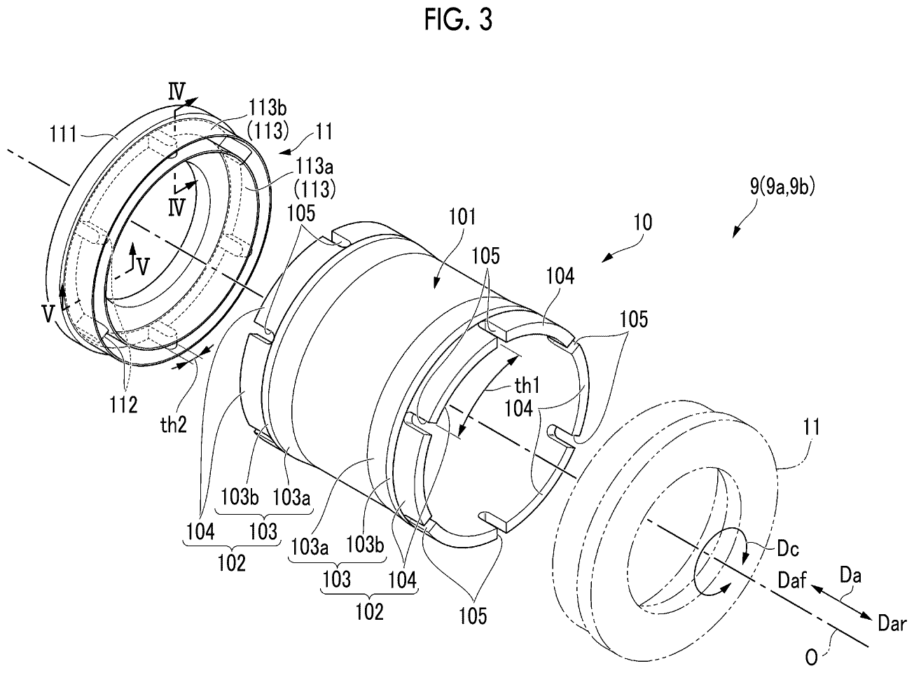

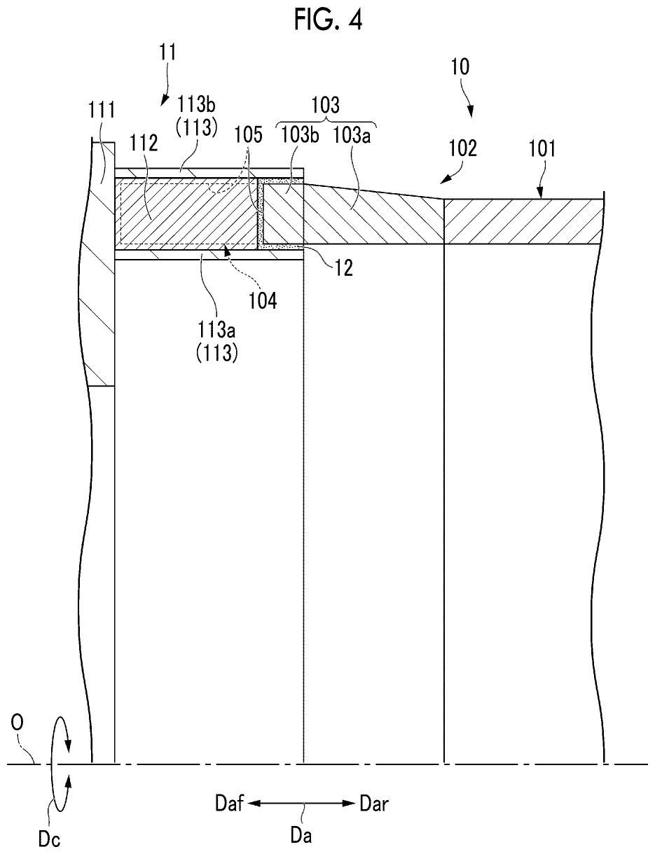

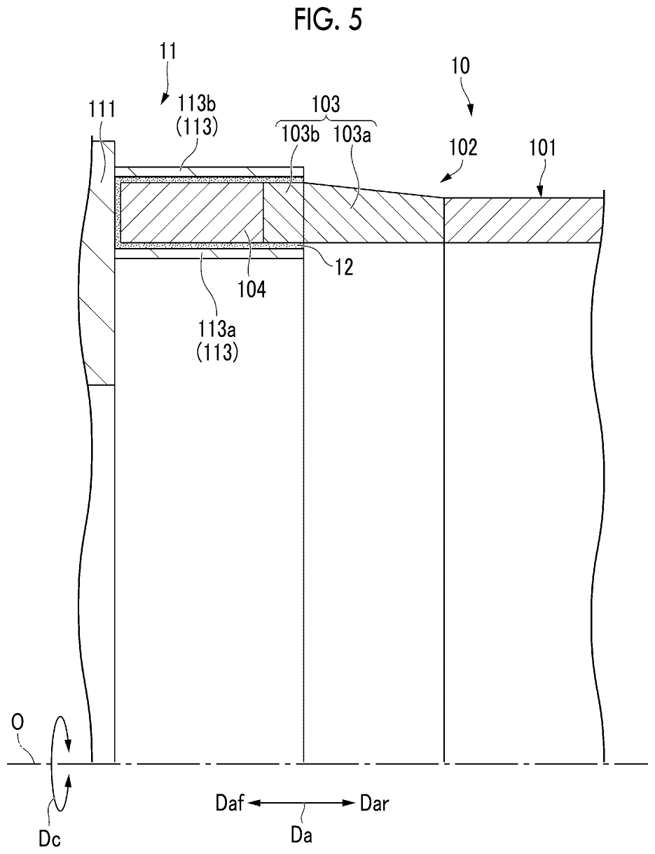

The power transmission shaft 9 is a shaft that connects two rotating devices and can transmit power from one device to the other device. Therefore, the power transmission shaft 9 in the present embodiment connects the engine 2 and the rear power distribution unit 6, and the rear power distribution unit 6 and the front power distribution unit 7 to each other as two devices. As shown in FIG. 3, the power transmission shaft 9 includes an FRP shaft 10, a metal flange 11, and an adhesive portion 12 (see FIG. 4 and FIG. 5).

### (FRP Shaft)

The FRP shaft 10 has a tubular shape extending about an axis O. The axis O in the present embodiment extends in the horizontal direction. Hereinafter, a direction in which the axis O extends is referred to as an “axial direction Da”, a circumferential direction with respect to the axis O is simply referred to as a “circumferential direction Dc”, and a direction perpendicular to the axis O is referred to as a “radial direction”. Further, of both sides in the axial direction Da, one side is simply referred to as “one side Daf”, and the opposite side is referred to as “the other side Dar”. In addition, a side approaching the axis O in the radial direction is referred to as a “radially inner side”, and the opposite side is referred to as a “radially outer side”. Therefore, the axial direction Da in the present embodiment coincides with the front-rear direction Df of the vehicle 100.

The FRP shaft 10 is formed of fiber reinforced plastics (FRP). The FRP shaft 10 includes a first cylindrical portion 101 and a second cylindrical portion 102.

The first cylindrical portion 101 has a cylindrical shape extending about the axis O. A pair of second cylindrical portions 102 are integrally connected to the first cylindrical portion 101 in the axial direction Da. The second cylindrical portion 102 is disposed on each of the one side Daf and the other side Dar with respect to the first cylindrical portion 101. As shown in FIG. 3, FIG. 4, and FIG. 5, the second cylindrical portion 102 includes a base portion 103 and a protruding portion 104.

Hereinafter, for convenience of description, the second cylindrical portion 102 disposed on the one side Daf with respect to the first cylindrical portion 101 will be described. Since the second cylindrical portion 102 disposed on the other side Dar with respect to the first cylindrical portion 101 has the same shape as the second cylindrical portion 102 disposed on the one side Daf with respect to the first cylindrical portion 101, the description thereof will be omitted.

The base portion 103 is integrally connected to the first cylindrical portion 101 from the one side Daf. The base portion 103 in the present embodiment includes a first base portion 103a having a truncated cone shape whose diameter increases from a connection portion with the first cylindrical portion 101 toward the one side Daf, and a second base portion 103b having a cylindrical shape integrally formed with the first base portion 103a from the one side Daf.

The protruding portion 104 protrudes from an end portion of the second base portion 103b on the one side Daf to the one side Daf. The plurality of protruding portions 104 are disposed at equal intervals in the circumferential direction Dc with gaps therebetween. In the present embodiment, for example, six protruding portions 104 are disposed in the circumferential direction Dc. An end portion of each protruding portion 104 in the circumferential direction Dc has a pair of surfaces facing the circumferential direction Dc. Therefore, the surfaces of the two protruding portions 104 adjacent to each other in the circumferential direction De face each other in the circumferential direction Dc. The surface of the protruding portion 104 rises in the axial direction Da from the end surface of the second base portion 103b on the one side Daf. Here, an angle formed by the surface of the protruding portion 104 and a virtual plane perpendicular to the axis O is, for example, 80° to 100°.

A gap defined by the surfaces of the two protruding portions 104 adjacent to each other in the circumferential direction Dc and the end surface of the second base portion 103b on the one side Daf in the present embodiment is a key groove 105. The key groove 105 extends in the axial direction Da.

### (Metal Flange)

The metal flange 11 is a member that connects the above-described device and the FRP shaft 10. The metal flange 11 is disposed between the device and the FRP shaft 10. A pair of metal flanges 11 are connected to the second cylindrical portion 102 of the FRP shaft 10 from the axial direction Da. The metal flange 11 is formed of, for example, a metal such as an alloy. The metal flange 11 includes a connection portion 111, a plurality of keys 112, and a wrap portion 113.

Hereinafter, of the pair of metal flanges 11, the metal flange 11 disposed on the one side Daf with respect to the FRP shaft 10 will be described. Since the metal flange 11 disposed on the other side Dar with respect to the FRP shaft 10 has the same shape as the metal flange 11 disposed on the one side Daf with respect to the FRP shaft 10, the description thereof will be omitted.

The connection portion 111 has an annular shape about the axis O. The connection portion 111 is connected to the above-described device so as to be rotatable about the axis O. The plurality of keys 112 protrude from the connection portion 111 to the other side Dar. The plurality of keys 112 are inserted into the key grooves 105 formed in the second cylindrical portion 102 one by one to be fitted into the key grooves 105. Therefore, as shown in FIG. 3, the plurality of (six) keys 112 are disposed at equal intervals in the circumferential direction De with intervals therebetween. The key 112 has a pair of surfaces facing the circumferential direction Dc. That is, the surface of the key 112 and the surface of the protruding portion 104 face each other in the circumferential direction Dc. Here, an angle formed by the surface of the key 112 and an virtual surface perpendicular to the axis O is 80° to 100°. The surface of the key 112 and the surface of the protruding portion 104 are in a state parallel to each other. The term “parallel” as used herein refers to a substantially parallel state, and a slight number of manufacturing errors and design tolerances are allowed.

Here, the thickness of the key 112 in the circumferential direction De is defined as th2, and the thickness of the protruding portion 104 in the circumferential direction Dc is defined as th1. The thickness th2 of the key 112 in the circumferential direction Dc is smaller than the thickness th1 of the protruding portion 104 in the circumferential direction Dc. In other words, the thickness th1 of the protruding portion 104 in the circumferential direction De is larger than the thickness th2 of the key 112 in the circumferential direction Dc. Here, the thickness in the circumferential direction Dc means the length of a virtual dimension line extending in the circumferential direction Dc.

A value obtained by dividing the thickness th1 of the protruding portion 104 in the circumferential direction Dc by the thickness th2 of the key 112 in the circumferential direction Dc is referred to as “th1/th2”. In the present embodiment, the following formula (i) is established.

$$1 < th 1 / th 2 \leq 15 \qquad ( i )$$

More preferred is the following formula (ii).

$$4 \leq th 1 / th 2 \leq 10 \qquad ( ii )$$

The wrap portion 113 is formed integrally with the connection portion 111 in a state of forming a cylindrical shape extending about the axis O. The wrap portion 113 is disposed on the other side Dar with respect to the connection portion 111. The wrap portion 113 includes an inner wrap portion 113a disposed radially inward of the key 112 and an outer wrap portion 113b disposed radially outward of the key 112.

The inner wrap portion 113a and the outer wrap portion 113b are disposed integrally with the key 112. Therefore, the plurality of keys 112 are sandwiched between the inner wrap portion 113a and the outer wrap portion 113b in the radial direction. End surfaces of the inner wrap portion 113a and the outer wrap portion 113b on the other side Dar are disposed on the other side Dar with respect to the plurality of keys 112. Therefore, a space in which the second base portion 103b is disposed is formed between the inner wrap portion 113a and the outer wrap portion 113b.

### (Adhesive Portion)

The adhesive portion 12 is formed of a synthetic resin. As illustrated in FIG. 5, the adhesive portion 12 is disposed between the protruding portion 104 and the connection portion 111 and between the protruding portion 104 and the wrap portion 113 without a gap, and connects the protruding portion 104 and the connection portion 111 and the protruding portion 104 and the wrap portion 113 to each other as an adhesive. In addition, although not shown in the drawings due to space limitations, the adhesive portion 12 is disposed between the protruding portion 104 and the key 112 without a gap, and connects the protruding portion 104 and the key 112 to each other as an adhesive.

Further, as illustrated in FIG. 4, the adhesive portion 12 is disposed between the second base portion 103b of the second cylindrical portion 102 and the wrap portion 113, and connects the second base portion 103b and the wrap portion 113 to each other as an adhesive. Therefore, the adhesive portion 12 is disposed in a gap formed between the FRP shaft 10 and the metal flange 11 in a region where the FRP shaft 10 and the metal flange 11 overlap each other in the radial direction, the circumferential direction Dc, and the axial direction Da. The thickness of the adhesive portion 12 in the present embodiment is, for example, 0.1 mm to 1.5 mm.

### Functions and Effects

Since the connection portions 111 of the pair of metal flanges 11 are rotatably connected to the device, the metal flanges 11 and the FRP shaft 10 connected to the metal flanges 11 rotate with the rotation of the device. That is, the power transmission shaft 9 including the metal flange 11 and the FRP shaft 10 is connected so as to bridge the two devices. Therefore, the power transmission shaft 9 can transmit the rotational torque of one device to the other device. At this time, stress concentration occurs in the connection portion between the metal flange 11 and the FRP shaft 10.

The configuration described in the above embodiment is characterized by the relationship between the thickness th1 in the circumferential direction De of the protruding portion 104 forming the key groove 105 together with the base portion 103 and the thickness th2 in the circumferential direction Dc of the key 112 fitted into the key groove 105. That is, the thickness th1 in the circumferential direction De of the protruding portion 104 formed of fiber reinforced plastic is larger than the thickness th2 in the circumferential direction Dc of the key 112 formed of metal. Specifically, when the thickness of the protruding portion 104 in the circumferential direction De is defined as th1 and the thickness of the key 112 in the circumferential direction De is defined as th2, 1<th1/th2≤15 is established.

Here, the key 112 is higher in rigidity than the protruding portion 104 between the protruding portion 104 formed of fiber reinforced plastic and the key 112 formed of metal. With the above configuration, for example, as compared with a case where the thicknesses in the circumferential direction De are the same, it is possible to equalize the difference in rigidity due to the difference in the material. That is, it is possible to suppress deformation of the protruding portion 104 when stress is concentrated on the protruding portion 104. Therefore, the power transmission shaft 9 can cope with transmission of a larger torque between two rotating devices.

A key 112 protruding in the axial direction Da from the connection portion 111 is fitted into a key groove 105 formed in the second cylindrical portion 102 and extending in the axial direction Da. For this reason, when the power transmission shaft 9 rotates with the rotation of the device, the generation of a force component toward the axial direction Da in the force acting on the key 112 and the second cylindrical portion 102 is suppressed. That is, the key 112 can be prevented from being pulled out of the key groove 105.

Further, according to the above-described configuration, since the wrap portions 113 formed integrally with the connection portion 111 and the plurality of keys 112 are disposed on the outer side and the inner side in the radial direction with respect to the keys 112, when the power transmission shaft 9 rotates, the movement of the protruding portion 104 in the radial direction is restricted by the wrap portions 113. Therefore, the occurrence of misalignment or the like between the FRP shaft 10 and the metal flange 11 can be suppressed.

In addition, according to the above-described configuration, since the adhesive portion 12 as an adhesive is disposed in the gap formed between the FRP shaft 10 and the metal flange 11, the adhesive portion 12 functions as a buffer material when the second cylindrical portion 102 and the key 112 are deformed due to, for example, thermal stress. That is, the adhesive portion 12 can suppress variations in the load applied to each of the second cylindrical portion 102 and the key 112. Therefore, it is possible to suppress the occurrence of damage such as deformation or wear of the second cylindrical portion 102 and the key 112, and as a result, it is possible to suppress aging deterioration of the power transmission shaft 9. In addition, since the adhesive portion 12 blocks the outside air, it is possible to prevent the connection portion 111, the key 112, and the wrap portion 113 from being corroded.

### OTHER EMBODIMENTS

Although the embodiments of the present disclosure have been described in detail with reference to the drawings, specific configurations are not limited to the configurations of the embodiments, and additions, omissions, substitutions, and other modifications of the configurations can be made without departing from the gist of the present disclosure.

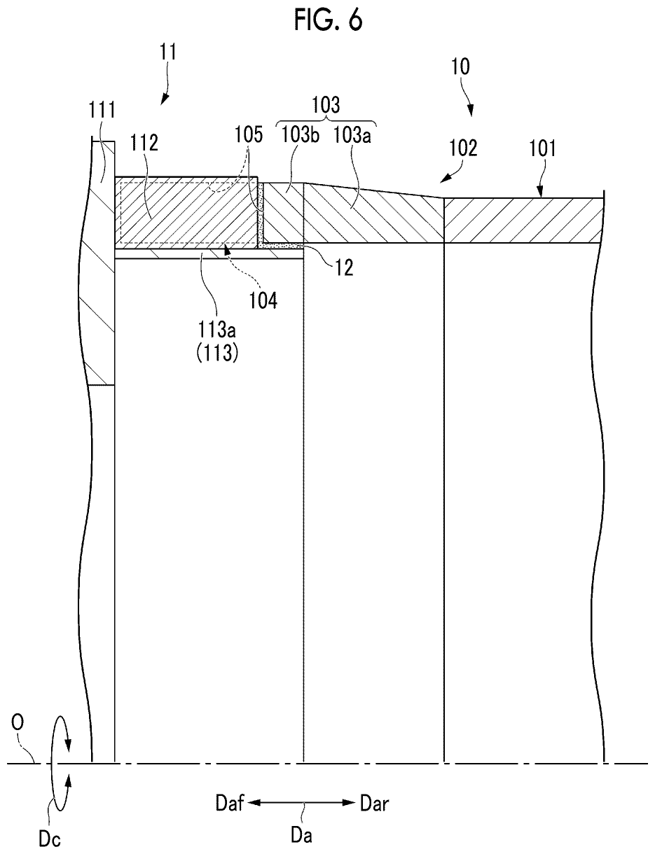

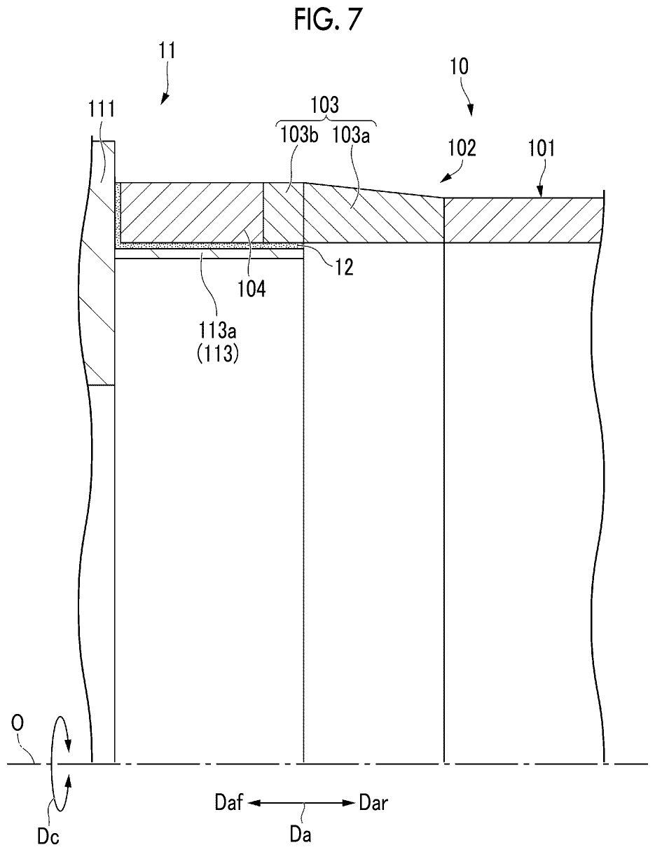

As shown in FIG. 6 and FIG. 7, the wrap portion 113 may have only the inner wrap portion 113a without having the outer wrap portion 113b. In this case, the adhesive portion 12 may be disposed between the protruding portion 104 and the connection portion 111 and between the protruding portion 104 and the inner wrap portion 113a.

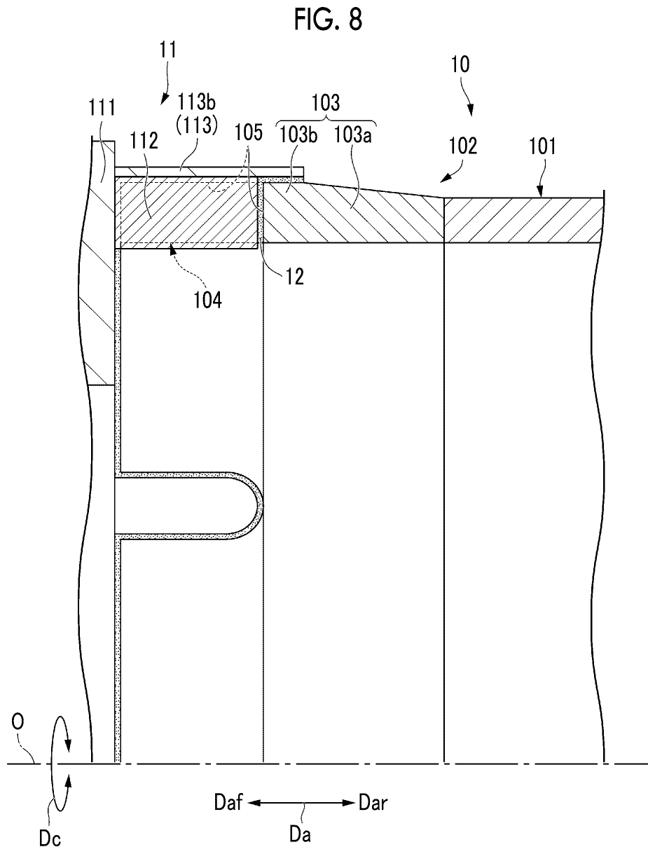

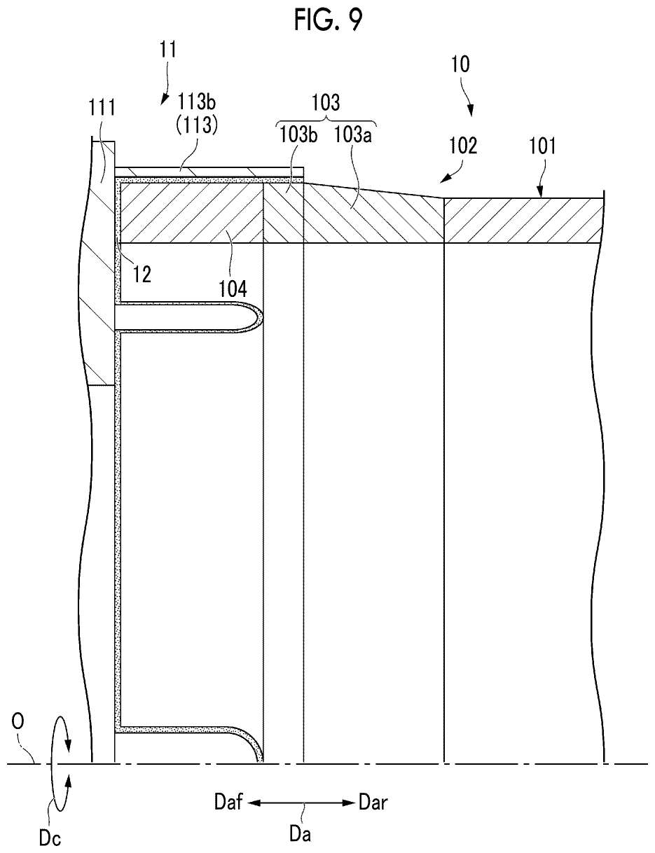

As shown in FIG. 8 and FIG. 9, the wrap portion 113 may include only the outer wrap portion 113b without including the inner wrap portion 113a. In this case, the adhesive portion 12 may be disposed between the protruding portion 104 and the connection portion 111 and between the protruding portion 104 and the outer wrap portion 113b.

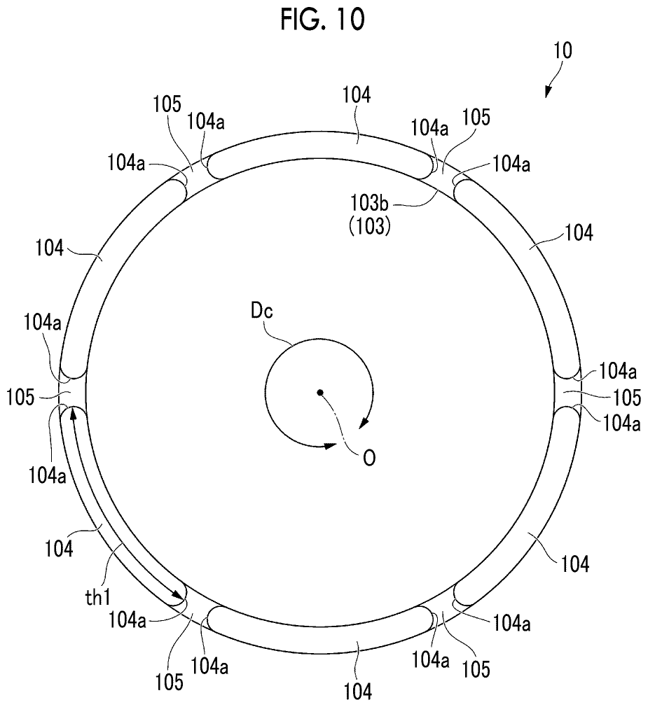

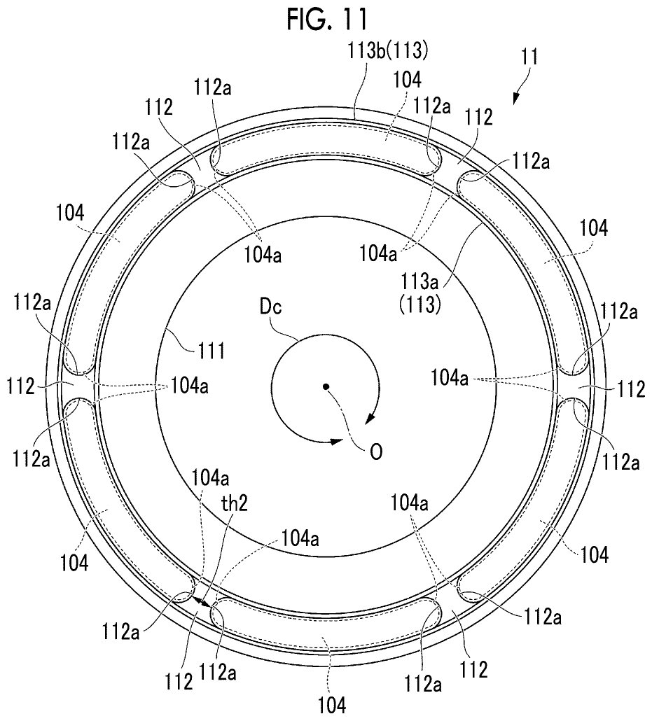

In addition, as shown in FIG. 10, an end portion of each protruding portion 104 in the circumferential direction De may have a convex curved surface 104a that is convex in the circumferential direction Dc. In this case, as illustrated in FIG. 11, the surface of each key 112 facing the circumferential direction De may form a concave curved surface 112a along the convex curved surface 104a of the protruding portion 104. Accordingly, compared to a case where each of the surface of the protruding portion 104 and the surface of the key 112 has a planar shape, it is possible to reduce stress concentration in the surface pressure received by the protruding portion 104 from the key 112. As a result, it is possible to suppress the occurrence of damage such as deformation or wear of the second cylindrical portion 102 and the key 112.

Further, in the embodiment, the configuration in which the vehicle 100 is a vehicle for traveling on rough terrain has been described, but the present invention is not limited thereto. The vehicle 100 may be, for example, an automobile. Even in this case, the power transmission shaft 9 may be used as a propeller shaft that connects an engine and a drive shaft (wheel drive shaft) as two devices included in an automobile to each other.

### Additional Notes

The power transmission shaft described in the embodiment and the vehicle equipped the same are understood as follows, for example.

(1) A power transmission shaft 9 for connecting two rotating devices to each other and capable of transmitting power from one device to the other device, including:
an FRP shaft 10 extending about an axis O; and
a pair of metal flanges 11 connected to the FRP shaft 10 in the axial direction Da,
in which the FRP shaft 10 includes
   a first cylindrical portion 101, and
   a pair of second cylindrical portions 102 integrally connected to the first cylindrical portion 101,
the second cylindrical portion 102 includes
   a base portion 103 connected to the first cylindrical portion 101, and
   a protruding portion 104 protruding from the base portion 103 in the axial direction Da and disposed at equal intervals in a circumferential direction Dc with gaps therebetween to form a plurality of key grooves 105 together with the base portion 103,
the metal flange 11 includes
   a connection portion 111 rotatably connected to the device, and
   a plurality of keys 112 protruding from the connection portion 111 in the axial direction Da and fitted into the key grooves 105 one by one, and
a thickness th1 of the protruding portion 104 in the circumferential direction Dc is larger than a thickness th2 of the key 112 in the circumferential direction Dc.

Accordingly, as compared with a case where the thickness th1 of the protruding portion 104 in the circumferential direction Dc and the thickness th2 of the key 112 in the circumferential direction De are the same, it is possible to suppress deformation of the protruding portion 104 when a load is concentrated on the protruding portion 104. That is, it is possible to suppress the occurrence of deformation or the like due to a difference in the material.

(2) The power transmission shaft 9 according to a second aspect is the power transmission shaft 9 according to the first aspect,
in which the following expression may be established when a thickness of the protruding portion 104 in the circumferential direction De is defined as th1, and
a thickness of the key 112 in the circumferential direction Dc is defined as th2,

$$1 < th 1 / th 2 \leq 15 .$$

As a result, it is possible to realize the above-described functions with more specific design values and enhance the above-described functions.

(3) The power transmission shaft 9 according to a third aspect is the power transmission shaft 9 according to the first aspect or the second aspect,
in which the metal flange 11 may further include a wrap portion 113 formed integrally with the connection portion 111 in a state of forming a cylindrical shape extending about the axis O, and
the wrap portion 113 may be disposed integrally with the plurality of keys 112 from one or more of an inner side and an outer side in a radial direction with respect to the plurality of keys 112.

Accordingly, when the power transmission shaft 9 rotates, the movement of the protruding portion 104 in the radial direction is restricted by the wrap portion 113.

(4) A power transmission shaft 9 according to a fourth aspect is the power transmission shaft 9 according to the third aspect, and may further include:
an adhesive portion 12 that is disposed at one or more of a position between the protruding portion 104 and the connection portion 111, a position between the protruding portion 104 and the key 112, and a position between the protruding portion 104 and the wrap portion 113, and connects the protruding portion 104 and the connection portion 111, the protruding portion 104 and the key 112, and the protruding portion 104 and the wrap portion 113 to each other as an adhesive.

Accordingly, when the second cylindrical portion 102 and the key 112 are deformed due to, for example, thermal stress, the adhesive portion 12 functions as a buffer material. That is, the adhesive portion 12 can suppress variations in the load applied to each of the second cylindrical portion 102 and the key 112.

(5) A power transmission shaft 9 according to a fifth aspect is the power transmission shaft 9 according to any one of the first aspect to the fourth aspect,
in which an end portion of the protruding portion 104 in the circumferential direction Dc may have a convex curved surface 104a that is convex in the circumferential direction Dc, and
a surface of the key 112 facing the circumferential direction Dc may form a concave curved surface 112a along the convex curved surface 104a.

Accordingly, it is possible to reduce the surface pressure that the protruding portion 104 receives from the key 112.

(6) A vehicle 100 according to a sixth aspect includes:
the power transmission shaft 9 according to any one of the first aspect to the fifth aspect.

### INDUSTRIAL APPLICABILITY

According to the present disclosure, it is possible to provide a power transmission shaft capable of transmitting a larger torque, and a vehicle equipped the same.

### REFERENCE SIGNS LIST

1: vehicle body
1f: leading edge
1r: trailing edge
2: engine
3: drive wheel
4: driven wheel
5: rear wheel drive shaft
6: rear power distribution unit
7: front power distribution unit
8: front wheel drive shaft
9: power transmission shaft
9a: first power transmission shaft
9b: second power transmission shaft
10: FRP shaft
11: metal flange
12: adhesive portion
100: vehicle
101: first cylindrical portion
102: Second cylindrical portion
103: base portion
103a: first base portion
103b: second base portion
104: protruding portion
104a: convex curved surface
105: key groove
111: connection portion
112: key
112a: concave curved surface
113: wrap portion
113a: inner wrap portion
113b: outer wrap portion
Da: axial direction
Daf: one side
Dar: other side
Dc: circumferential direction
Df: front-rear direction
Dff: front side
Dfr: rear side
Dw: left-right direction
th1: thickness in the protruding portion in circumferential direction
th2: thickness of key in circumferential direction
O: axis

1. A power transmission shaft for connecting two rotating devices to each other and capable of transmitting power from one device to the other device, comprising:
an FRP shaft extending about an axis; and
a pair of metal flanges connected to the FRP shaft in the axial direction,
wherein the FRP shaft includes
a first cylindrical portion, and
a pair of second cylindrical portions integrally connected to the first cylindrical portion,
the second cylindrical portion includes
a base portion connected to the first cylindrical portion, and
a protruding portion protruding from the base portion in the axial direction and disposed at equal intervals in a circumferential direction with gaps therebetween to form a plurality of key grooves extending in the axial direction together with the base portion,
the metal flange includes
a connection portion rotatably connected to the device, and
a plurality of keys protruding from the connection portion in the axial direction and fitted into the key grooves one by one, and
a thickness of the protruding portion in the circumferential direction is larger than a thickness of the key in the circumferential direction.

2. The power transmission shaft according to claim 1,
wherein the following expression is established when a thickness of the protruding portion in the circumferential direction is defined as th1, and
a thickness of the key in the circumferential direction is defined as th2,
$$1 < th 1 / th 2 \leq 15 .$$

3. The power transmission shaft according to claim 1,
wherein the metal flange further includes a wrap portion formed integrally with the connection portion in a state of forming a cylindrical shape extending about the axis, and
the wrap portion is disposed integrally with the plurality of keys from one or more of an inner side and an outer side in a radial direction with respect to the plurality of keys.

4. The power transmission shaft according to claim 3, further comprising: an adhesive portion that is disposed at one or more of a position between the protruding portion and the connection portion, a position between the protruding portion and the key, and a position between the protruding portion and the wrap portion, and connects the protruding portion and the connection portion, the protruding portion and the key, and the protruding portion and the wrap portion to each other as an adhesive.

5. The power transmission shaft according to claim 1,
wherein an end portion of the protruding portion in the circumferential direction has a convex curved surface that is convex in the circumferential direction; and
a surface of the key facing the circumferential direction forms a concave curved surface along the convex curved surface.

6. A vehicle comprising:
the power transmission shaft according to claim 1.
